(19) United States
(12) Patent Application Publication
(10) Pub. No.: US 2020/0250555 A1
(43) Pub. Date: Aug. 6, 2020

(54) METHOD AND SYSTEM FOR CREATING A GAME OPERATION SCENARIO BASED ON GAMER BEHAVIOR PREDICTION MODEL

(71) Applicant: Electronics and Telecommunications Research Institute, Daejeon (KR)

(72) Inventors: Hyoung Jin KWON, Sejong-si (KR); Seong Il YANG, Daejeon (KR)

(73) Assignee: Electronics and Telecommunications Research Institute, Daejeon (KR)

(21) Appl. No.: 16/778,637

(22) Filed: Jan. 31, 2020

(30) Foreign Application Priority Data
Jan. 31, 2019 (KR) 10-2019-0013153

(51) Int. Cl. G06N 5/04; G06N 20/00; A63F 13/67

(52) U.S. Cl. CPC G06N 5/04; A63F 2300/6027; A63F 13/67; G06N 20/00

(57) ABSTRACT

The present invention provides a gamer behavior prediction modeling system based on time-series data conforming to an in-game behavior of a gamer and an environment attribute variation associated with a game in an online game service. Also, the present invention provides a method and system of generating a game operating scenario on the basis of a gamer behavior prediction model.

### CROSS-REFERENCE TO RELATED APPLICATIONS

This application claims priority under 35 U.S.C. § 119 to Korean Patent Application No. 10-2019-0013153, filed on Jan. 31, 2019, the disclosure of which is incorporated herein by reference in its entirety.

### TECHNICAL FIELD

The present invention relates to a method and system of generating a game operating scenario, and more particularly, to a gamer behavior prediction modeling system and a method and system of generating a game operating scenario on the basis of a gamer behavior prediction model.

### BACKGROUND

Recently, in an online game service, it is possible to continuously collect individual play data performed by each gamer, and thus, a precise model for predicting a gamer behavior or goods may be generated. A gamer modeling method is for planning various prediction models of a gamer, predicting the amount of goods or a breakaway of the gamer, and using a prediction result in making decision for an in-game event or patch updating of a game.

However, there are various variables which affect gamer modeling-based prediction, and it is very difficult to quantize an influence of each of the variables. For example, in a deep learning method, a function to be predicted approximates to a more complicated nonlinear function, and thus, when data is sufficient, model prediction performance may be enhanced compared to a related art method. However, as a model is more complicated, it is more difficult to explain a value of an input variable affecting a value predicted by the deep learning method.

Furthermore, in a case where an input is assigned as a sequence of an input variable varying with time instead of that a value of an input variable is assigned as a static type or a snapshot type at a specific time with time, a dynamic model for quantizing whether a predicted value is determined as an influence of an arbitrary input variable at an arbitrary time is needed.

### SUMMARY

Accordingly, the present invention provides a gamer behavior prediction modeling system based on time-series data conforming to an in-game behavior of a gamer and an environment attribute variation associated with a game in an online game service.

The present invention provides a method and system of generating a game operating scenario on the basis of a gamer behavior prediction model.

A gamer behavior prediction modeling system and a method of system of generating a game operating scenario based thereon implement a dynamic model which predicts a target variable value on the basis of time series game attribute data and quantitatively analyzes an influence of each game attribute data of a target variable value.

The advantages, features and aspects of the present invention will become apparent from the following description of the embodiments with reference to the accompanying drawings, which is set forth hereinafter.

In one general aspect, a gamer behavior prediction modeling system includes an extractor configured to extract at least one piece of game attribute data affecting a target variable, a target variable predictor configured to determine a prediction value of the target variable from the at least one piece of game attribute data, and an attribute influence analyzer configured to determine an influence of the at least one piece of game attribute data corresponding to the prediction value.

The extractor may extract the at least one piece of game attribute data to continuously output a series of game attribute data at every unit time, and

[symbol]

The attribute influence analyzer may determine an influence of the at least one piece of game attribute data corresponding to the prediction value at a specific time.

In another general aspect, a method of generating a game operating scenario by using target variable modeling based on at least one piece of game attribute data includes building at least one prediction model determining a prediction value of a target variable on the basis of the at least one piece of game attribute data, determining an operating factor of the game operating scenario corresponding to the at least one prediction model, generating a control signal for determining a combination of active prediction models, and driving the combination of the active prediction models according to the control signal to generate the prediction value of the target variable, based on the at least one piece of game attribute data and the operating factor.

The at least one prediction model may extract the at least one piece of game attribute data at every unit time to obtain a series of game attribute data and may determine the prediction value of the target variable on the basis of the obtained series of game attribute data.

The method may further include, when the operating factor is added, additionally building a prediction model with the added operating factor reflected therein.

The determining of the operating factor may include determining the operating factor on the basis of an intention of operating the game operating scenario and a response sensitivity of a gamer corresponding to the intention.

The at least one prediction model may determine an influence of the at least one piece of game attribute data corresponding to the prediction value.

The generating of the control signal may include determining the combination of the active prediction models on the basis of a similarity between an influence of the at least one piece of game attribute data determined based on learning data and an influence of the at least one piece of game attribute data determined based on live data.

The generating of the control signal may include determining all prediction models as the active prediction models.

The control signal may determine a weight value of the prediction value.

The generating of the prediction value may include weight-averaging prediction values determined by the at least one prediction model on the basis of the weight value to generate the prediction value.

The weight value may be determined based on a similarity between an influence of the at least one piece of game attribute data determined based on learning data and an influence of the at least one piece of game attribute data determined based on live data.

The method may further include evaluating the game operating scenario on the basis of the prediction value.

The at least one prediction model may determine an influence of the operating factor and an influence of the at least one piece of game attribute data corresponding to the prediction value.

The method may further include evaluating the game operating scenario on the basis of the influence of the operating factor and the influence of the at least one piece of game attribute data.

The method may further include varying the operating factor of the game operating scenario corresponding to the at least one prediction model.

The generating of the control signal and the generating of the prediction value may be performed based on a varied operating factor.

The method may further include performing a simulation on the game operating scenario on the basis of live data and adding the at least one piece of game attribute data on the basis of a result of the simulation.

In another general aspect, a system for generating a game operating scenario by using target variable modeling based on at least one piece of game attribute data includes an extractor configured to extract the at least one piece of game attribute data, a prediction modeling unit configured to build at least one prediction model for determining a prediction value of a target variable on the basis of the at least one piece of game attribute data, an operating factor determiner configured to determine an operating factor of the game operating scenario corresponding to the at least one prediction model, a control signal generator configured to generate a control signal for determining a combination of active prediction models, a prediction value generator configured to drive the combination of the active prediction models according to the control signal to generate the prediction value of the target variable, based on the at least one piece of game attribute data and the operating factor, and a validator configured to perform a simulation on the game operating scenario to validate the game operating scenario.

Other features and aspects will be apparent from the following detailed description, the drawings, and the claims.

### BRIEF DESCRIPTION OF THE DRAWINGS

FIG. 1 is a diagram illustrating an operation process of a gamer behavior prediction modeling system according to an embodiment of the present invention.

FIG. 2 is a block diagram of a gamer behavior prediction modeling system according to an embodiment of the present invention.

FIG. 3 is a diagram illustrating an operation process of a game operating scenario generating system according to an embodiment of the present invention.

FIG. 4 is a flowchart illustrating an operation process of a game operating scenario generating method according to an embodiment of the present invention.

FIG. 5 is a block diagram of a game operating scenario generating system according to an embodiment of the present invention.

### DETAILED DESCRIPTION OF EMBODIMENTS

The present invention may, however, be embodied in different forms and should not be construed as limited to the embodiments set forth herein. Rather, these embodiments are provided so that this disclosure will be thorough and complete, and will fully convey the scope of the present invention to those skilled in the art. The terms used herein are for the purpose of describing particular embodiments only and are not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Before describing embodiments of the present invention, for promotion of understanding and convenience of description, an idea of the present invention will be briefly described.

Gamer in-game modeling may be affected whenever a game play is performed based on preceding factors of a game, in addition to a gamer attribute of a target variable to be modeled. When the gamer in-game modeling is simultaneously affected by various factors, a prediction method of quantizing an influence of each of the factors may be needed. Also, when it is required to generate a game operating policy (for example, designing of a game update or an in-game event in an online game service) for obtaining a desired variation, a model for predicting a specific target variable sequence from a sequence input and a method of quantizing an influence of each factor may be needed for obtaining a desired effect by controlling various factor variables affecting the variable with sequence.

A gamer behavior prediction modeling system according to an embodiment of the present invention may calculate a sequence of pieces of game attribute data affecting a gamer target variable, receive the calculated sequence of the pieces of game attribute data to predict the gamer target variable, and quantize an influence of each game attribute data corresponding to a prediction value of a target variable.

That is, in prediction of a target variable value based on time-series game attribute data according to an embodiment of the present invention, an input variable affecting a variation of a prediction value and a significance of a corresponding input variable may be checked in addition to simply checking only a prediction value when the prediction value varies.

Moreover, a variation of an input game factor for causing a desired variation of a specific target variable may be detected based on the prediction model according to an embodiment of the present invention, and a predicted target variable sequence may be obtained from a sequence of specific game attribute data. Therefore, when a game operator desires to set a game operating policy, a game operating scenario for controlling an input variable may be generated for causing a variation of a target variable of a desired type.

Furthermore, according to an embodiment of the present invention, when a sequence of new game attribute data differing from a pattern of a sequence of a previously input game attribute data is input, a previous prediction model may be updated to reflect in the sequence of the new game attribute data.

Hereinafter, embodiments of the present invention will be described in detail with reference to the accompanying drawings.

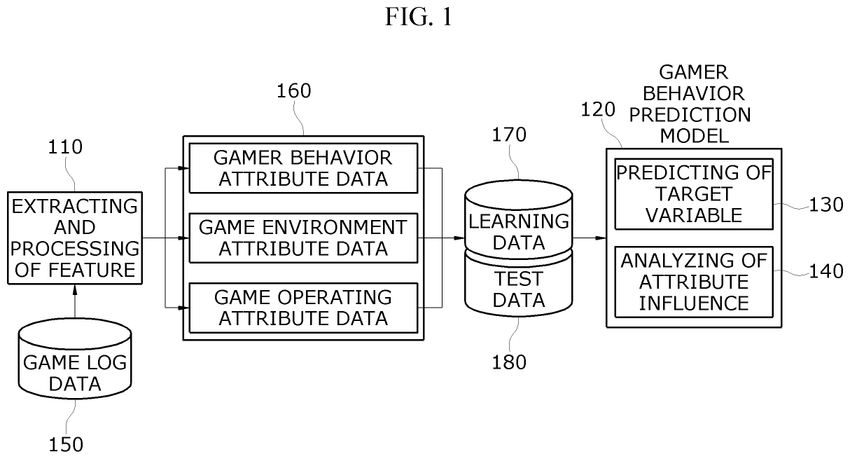

FIG. 1 is a diagram illustrating an operation process of a gamer behavior prediction modeling system 100 according to an embodiment of the present invention.

To describe a configuration of the gamer behavior prediction modeling system 100 for performing gamer behavior prediction modeling of FIG. 1, the gamer behavior prediction modeling system 100 may include an extractor 210 which extracts at least one piece of game attribute data affecting a target variable, a target variable predictor 220 which determines a prediction value of the target variable from the game attribute data, and an attribute influence analyzer 230 which determines an influence of each game attribute data corresponding to the prediction value of the target variable. Additionally, the gamer behavior prediction modeling system 100 may further include a storage unit 240 which stores game log data and learning data.

An operation process of the gamer behavior prediction modeling system 100 will be described below with reference to FIG. 1.

In an operation 110 of extracting and processing a feature, the extractor 210 may extract variable factors affecting a target variable, which is to be modeled, from raw data representing a behavior of a gamer or game log data 150.

That is, the extractor 210 may process the game log data 150 to extract a feature in the operation 110 and may extract at least one piece of game attribute data 160 on the basis of the extracted feature. Here, the game attribute data 160 may correspond to a variable factor affecting a target variable which is to be modeled in the gamer behavior prediction modeling system 100.

The at least one piece of game attribute data 160 may include gamer behavior attribute data, game environment attribute data, and game operating attribute data. In an embodiment of the present invention, the game attribute data 160 may be classified into the gamer behavior attribute data, the game environment attribute data, and the game operating attribute data on the basis of an attribute thereof, but is not limited thereto and may include a feature selection process for detecting a variable having a causal relationship or a correlation with a variable determined as a target. For example, the gamer behavior attribute data may include a frequency number of game, an access time, a game level, a battle history, a game tendency, a game colleague, an item purchase history, and an in-game specific activity history. For example, the game environment attribute data may include information about various resources and information about goods provided to a game. The game operating attribute data may be data corresponding to an operating attribute described below and may include an attribute which is desired by a game operating scenario by reflecting a game operating policy. For example, the game operating attribute data may be the amount of variation of goods before and after applying an event. For example, the game operating attribute data may be the amount of variation of the number of active gamers before and after applying a specific event.

In the operation 110 of extracting and processing a feature, the extractor 210 may extract the at least one piece of game attribute data 160 to continuously output a series of game attribute data at every unit time. The at least one piece of game attribute data 160 may be expressed as an input vector having each game attribute data as a factor. For example, when the extractor 210 extracts ten pieces of game attribute data 160 at every unit time, a ten-dimensional (10D) input vector having ten pieces of game attribute data as a factor may be output at every unit time in the operation 110. That is, the extractor 210 may extract a sequence of an input vector including the at least one piece of game attribute data 160 which is extracted in the operation 110. In other words, the extractor 210 may extract a series of input vectors in the operation 110. The series of input vectors may provide time-series game attribute data 160 because a game attribute data 160 value based on time is reflected therein. Here, time series may denote that an input vector is extracted at every unit time or at every time step, and thus, a sequence of the input vector is extracted.

A gamer behavior prediction model 120 may model a gamer behavior from at least one piece of game attribute data (i.e., an input vector) output from the extractor 210. That is, the gamer behavior prediction model 120 may be a model for modeling a target variable on the basis of time-series game attribute data and may include a target variable predicting operation 130 and an attribute influence analyzing operation 140. In order to validate the gamer behavior prediction model 120, data may be divided into learning data 170 and test data 180 and the gamer behavior prediction model 120 may be configured for each of the learning data 170 and the test data 180. For example, a cross validation operation of validating a corresponding gamer behavior prediction model 120 may be performed by applying the test data 180 to the gamer behavior prediction model 120 configured for the learning data 170.

In the target variable predicting operation 130, the target variable predictor 220 may determine a prediction value of a target variable on the basis of at least one piece of game attribute data output from the extractor 210. For example, classification or regression of supervised learning may be applied to data including a true label of a target variable.

In the operation 140 of analyzing an influence of an attribute 140, the attribute influence analyzer 230 may determine an influence of each game attribute data corresponding to a prediction value of a target variable at a specific time.

That is, in the operation 140, the attribute influence analyzer 230 may calculate an influence of each input game attribute data corresponding to a specific prediction value which is determined by the target variable predictor 220 in the operation 130. Here, the influence of each input game attribute data may be calculated by units of input features at each time. For example, the influence of each input game attribute data may be calculated by units of input vectors at each time.

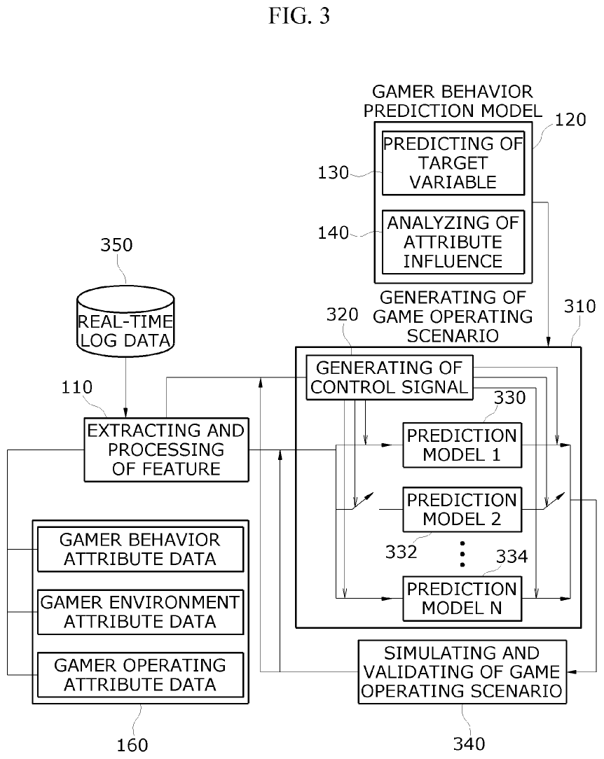

The attribute influence analyzer 230 may determine an influence of each game attribute data at a specific time in the operation 140, and thus, the gamer behavior prediction modeling system 100 may determine whether arbitrary attribute data at an arbitrary time is significant to prediction of a target variable. That is, a significance of game attribute data of a target variable may be determined and compared. Also, an influence of each game attribute data which is determined by the attribute influence analyzer 230 in the operation 140 may be time-series data, and thus, may be used as a criterion for determining a time for which a corresponding influence is continued. The extractor 210 may select an arbitrary variable which is to be used as an input variable of the gamer behavior prediction model 120 or prediction models 320, 332, and 334 with reference to FIGS. 1 and 3, based on the determined influence.

The gamer behavior prediction modeling system 100 according to an embodiment of the present invention may generate a game operating scenario on the basis of the gamer behavior prediction model 120.

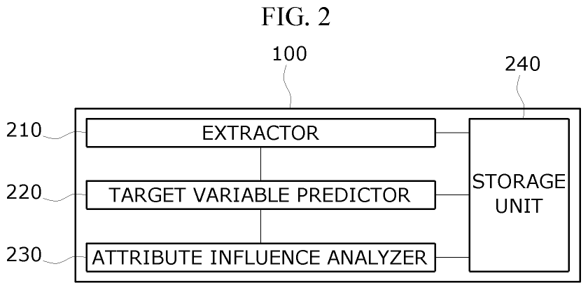

FIG. 2 is a block diagram of the gamer behavior prediction modeling system 100 according to an embodiment of the present invention. As described above, the gamer behavior prediction modeling system 100 may include the extractor 210, the target variable predictor 220, and the attribute influence analyzer 230, and additionally, may further include the storage unit 240.

FIG. 3 is a diagram illustrating an operation process of a game operating scenario generating system according to an embodiment of the present invention.

The game operating scenario generating system may generate a game operating scenario by using target variable modeling based on at least one piece of game attribute data. That is, the game operating scenario generating system may generate the game operating scenario in an environment where game data is input in real time, based on a prediction model learned through the gamer behavior prediction modeling system 100 and may perform a simulation on whether a desired variation occurs, based on the generated game operating scenario.

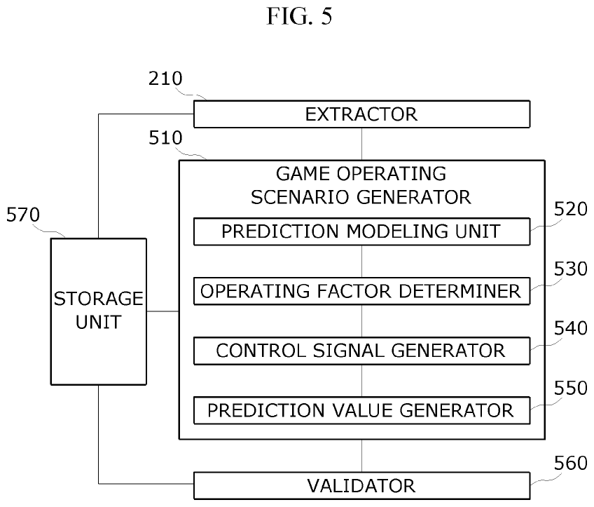

Before describing an operation process of the game operating scenario generating system of FIG. 3, a configuration of the game operating scenario generating system will be first described with reference to FIG. 5.

The game operating scenario generating system may include an extractor 210 which extracts at least one piece of game attribute data, a game operating scenario generator 510 which generates a game operating scenario on the basis of the at least one piece of game attribute data, and a validator 560 which simulates and validates the generated operating scenario, and additionally, may include a storage unit 570 which stores game log data. In an embodiment, the extractor 210 may correspond to the extractor 210 of the gamer behavior prediction modeling system 100 of FIG. 2.

The game operating scenario generator 510 may include a prediction modeling unit 520 which builds at least one prediction model for determining a prediction value of a target variable on the basis of at least one piece of game attribute data, an operating factor determiner 530 which determines an operating factor of a game operating scenario desired based on each of the at least one prediction model, a control signal generator 540 which generates a control signal for determining a combination of active prediction models, and a prediction value generator 550 which drives the combination of the active prediction models according to the control signal to generate the prediction value of the target variable, based on the game attribute data and the operating factor. Additionally, the game operating scenario generator 510 may include an attribute influence analyzer.

The game operating scenario generating system may generate a game operating scenario having a target variable value which varies based on a type or a method desired by a game operator in a game operating policy. Here, the game operating scenario may be a detailed plan for realizing the game operating policy, and the game operating factor may express a type or a method desired by the game operator. In an embodiment, the game operating scenario generating system may determine a prediction model for predicting a prediction value of the target variable and an influence of each game attribute data on the basis of the at least one piece of game attribute data, the at least one game operating factor, and the control signal for determining the combination of the active prediction models and may adjust the prediction model, the game operating factor, and the control signal to generate the game operating scenario suitable for a desired game operating policy. Here, the prediction model may use a single prediction model or a plurality of prediction models.

Referring again to FIG. 3, in an operation 110 of extracting and processing a feature, the extractor 210 may extract at least one piece of game attribute data like the operation 110 of FIG. 1, and in this case, in order to generate a real-time operating scenario, the extractor 210 may receive real-time log data 350 instead of game log data 150 and may extract the at least one piece of game attribute data from the real-time log data 350. The extractor 210 may extract the at least one piece of game attribute data from the real-time log data 350 at every unit time to continuously output a series of game attribute data.

At least one piece of game attribute data 160 may include gamer behavior attribute data, game environment attribute data, and game operating attribute data. The at least one piece of game attribute data 160 may be classified into the gamer behavior attribute data, the game environment attribute data, and the game operating attribute data on the basis of an attribute thereof, but is not limited thereto and may include a feature selection process for detecting a variable having a causal relationship or a correlation with a variable determined as a target.

In an operation 310 of generating a game operating scenario, the game operating scenario generator 510 may generate a game operating scenario by using a gamer behavior prediction model which is learned based on the process of FIG. 1.

The prediction modeling unit 520 may build at least one prediction model.

In the game operating scenario, an input feature affecting a prediction value of a target variable may vary based on a target variable to be predicted, and an influence of one feature may vary with time, whereby there may be various patterns of a significance of the input feature based on time. Therefore, in order to generate the game operating scenario on the basis of a pattern of an influence of corresponding game attribute data and specific game attribute data interesting to the game operator, a prediction model specialized for each pattern may be needed, and thus, the prediction modeling unit 520 may build at least one prediction model. For example, the prediction modeling unit 520 may build a prediction model 1 330 and a prediction model 2 332 to a prediction model N 334 on the basis of a pattern of an influence of game attribute data. For example, the prediction modeling unit 520 may build at least one prediction model on the basis of a pattern of game operating attribute data.

The prediction modeling unit 520 may allow the built at least one prediction model to learn based on learning data.

The operating factor determiner 530 may determine an operating factor of each prediction model.

The control signal generator 540 may generate the control signal for activating the prediction model so as to predict a target variable. Some or all of the at least one prediction model may be activated based on the control signal and may configure a combination of active prediction models.

The prediction value generator 550 may drive the combination of the active prediction models according to the control signal to generate the prediction value of the target variable, based on the at least one piece of game attribute data and the operating factor.

The attribute influence analyzer may analyze an influence of the operating factor and an influence of the at least one piece of game attribute data in association with the prediction value of the target variable.

Therefore, in the game operating scenario generator 510, the prediction modeling unit 520 may build and learn a plurality of prediction models, the operating factor determiner 530 may determine an operating factor corresponding to a specific game operating scenario in association with each prediction model and may configure a combination of active prediction models according to the control signal generated by the control signal generator 540, and the prediction value generator 550 may perform a target prediction test thereon.

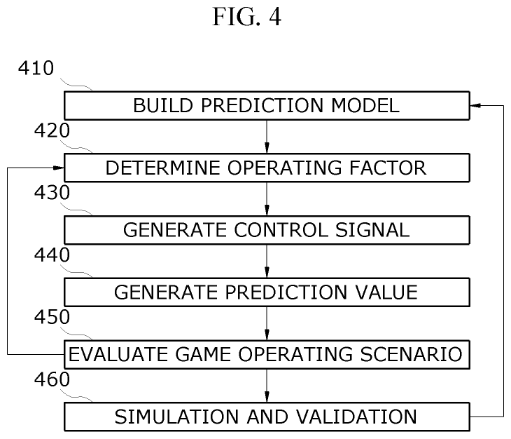

The operating factor determiner 530, the control signal generator 540, and the prediction value generator 540 will be described below in detail with reference to FIGS. 4 and 5.

The validator 560 may apply a game operating scenario, generated by game operating scenario generator 510 in the operation 310, to a live game service to perform a simulation. The validator 560 may perform a simulation on variations of other variables in cooperation with a target variable value predicted from a combination of active prediction models of the game operating scenario generator 510. The game operating scenario generating system may generate a game operating scenario by using a feedback method which corrects the game operating scenario on the basis of a result of the simulation and performs a simulation again, thereby detecting an optimal game operating scenario for realizing a game operating policy.

The game operating scenario generating system may apply a finally generated game operating scenario to real game data, and then, real game log data 350 with the game operating scenario reflected therein may be stored in the storage unit 570. Since the game operating scenario generating system operates based on the real game log data 350, the game operating scenario generator 510 including a prediction model may be updated through online learning. In a case where the gamer behavior prediction modeling system 100 operates based on the real game log data 350 with reference to FIG. 2, the gamer behavior prediction model 120 may be updated through online learning. When a pattern of a time-series influence of a feature differing from conventional prediction models 330, 332, and 334 is detected, a prediction model with a detection result reflected therein may be additionally built by the prediction modeling unit 520 of the game operating scenario generator 510.

FIG. 4 is a flowchart illustrating an operation process of a game operating scenario generating method according to an embodiment of the present invention.

The game operating scenario generating method may generate a game operating scenario by using target variable modeling based on at least one piece of game attribute data.

In an operation 410, referring to FIG. 5, the prediction modeling unit 520 may build at least one prediction model for determining a prediction value of a target variable on the basis of game attribute data. The prediction modeling unit 520 may build a prediction model corresponding to the target variable. In order to increase an accuracy of interpretation based on a prediction result and/or an accuracy of prediction of the prediction model, the prediction modeling unit 520 may build at least one prediction model corresponding to one target variable. The at least one prediction model may be combined to configure an ensemble model. For example, referring to FIG. 3, N (where N is an integer of 2 or more) number of prediction models including the prediction model 1 330 and the prediction model 2 332 to the prediction model N 334 may each be a prediction model which is built to predict the same target variable and may be an ensemble model where the N prediction models are combined.

The prediction modeling unit 520 may perform cross validation based on learning data and test data to validate the ensemble model.

For example, in an initiation step of a game which does not perform an event, the prediction modeling unit 520 may build one default model by using all data. Time-series data of game attribute data, generated when a game operation creates a game operating scenario and assigns a variation such as addition of an operating factor to a game (for example, a patch update or an in-game event of the game), may have a characteristic differing from that of previous data. The prediction modeling unit 520 may additionally generate a new prediction model using time-series data having a new characteristic. When a real value of an operating factor obtained by applying a game operating scenario and a true label of a later prediction model are assigned, the additionally generated prediction model may perform learning by using the assigned real value and true label. A new prediction model may be added by performing an even in a default model, and moreover, may be added even when time-series data of a new pattern incapable of being expressed by a combination of previous models due to an event in previous N number of prediction models is generated. Also, a new prediction model may be added when a new item is added due to a variation of a game environment based on an update or there is a limitation in expressing a previous model due to a change in in-game balancing.

However, in a case where an operating factor is added to a new prediction model, the operating factor may be applied by adding an extended operating factor to learning of a previous prediction model, in addition to performing learning of the new prediction model as described above. Such extension may be performed by a batch or incremental method. In other words, such a method may be a method where data of a previous prediction model is defined by adding an extended operating factor and learning of all previous prediction models are performed again, and a prediction model based on extension of an operating factor is built by extending a previous prediction model and the extended prediction model is learned based on new data where an operating factor extends.

Referring to FIG. 5, the extractor 210 may extract a feature from live data to generate test data which is an input of a prediction model built in the operation 410. Here, the input of the prediction model may be a sequence of an input vector configured with at least one piece of game attribute data. The sequence of the input vector may be time-series data including an input vector which is extracted at every unit time. The prediction model may determine a prediction value of a target variable on the basis of a series of game attribute data obtained by extracting game attribute data at every unit time.

In an operation 420, referring to FIG. 5, the operating factor determiner 530 may determine an operating factor of a game operating scenario corresponding to a prediction model. The operating factor determiner 530 may set an operating factor in which a game operating scenario corresponding to each prediction model built by the prediction modeling unit 520 is reflected.

That is, in the operation 420, the operating factor determiner 530 may determine a value of an operating attribute so as to generate a game operating scenario.

For example, an operating factor may be defined as the kind of compensation based on a game event, and in detail, may be defined as the kind of compensation provided to a gamer according to performing a specific mission. Alternatively, the operating factor may be defined as an expected effect of each of economic attributes (goods) of all users which occur when an event is applied to a game. Alternatively, the operating factor may be defined as an expected effect of cluster-based goods by clustering users instead of goods of all users. Alternatively, the operating factor may be defined as the amount of variation of goods based on each user when an event is applied to each user. In order to reflect a user-based operating factor, a value of an operating factor for each user may be applied based on a corresponding user in learning, and in a new user, since there is no value in learning, an average value of values of operating factors of other users may be used.

A value of an operating factor may use a fixed value, or may use an average value of values of operating factors used in a previous model in data learning. Alternatively, a value of an operating factor may be determined as a value which is provided from a prediction model corresponding to another target variable, or may be determined as a value which is obtained by reflecting a significance of the operating factor determined by another analysis method.

For example, in a case where a gamer operator desires to increase or consume goods possessed by a gamer, a value representing an intention of the game operator may be set as an operating attribute. Also, for example, the operating factor determiner 530 may set an operating factor on the basis of a response of the gamer to an operating scenario. For example, in a case where the game operator performs a game update in which an operating attribute set based on an intention of the game operator is reflected, a response sensitivity representing whether the gamer behaves based on the intention of the game operator and whether a response of the gamer matches the intention of the game operator may be reflected as an operating attribute. That is, a personal response sensitivity corresponding to an operating intention may be applied to a value of an operating factor. As another example, the operating factor determiner 530 may use, as an operating attribute, a value of a combination of an operating intention and a personal response sensitivity based on a weight value. That is, the operating factor determiner 530 may generate an operating attribute on the basis of at least one of an intention of operating a game operating scenario and a response sensitivity of the gamer corresponding to the operating intention.

An operating attribute may be fundamentally and identically applied to all user in a game, but may be applied to only a user satisfying a specific condition. Alternatively, the operating attribute may be applied to a customized person, and to this end, a value of the operating attribute may be applied to game operating attribute data of personal game attribute data 160 on the basis of a gamer behavior prediction model according to an intention of a game operating scenario.

In an operation 430, referring to FIG. 5, the control signal generator 540 may generate a control signal for determining a combination of active prediction models.

In the operation 430, the control signal generator 540 may generate a control signal for selecting a prediction model, which is to be activated, from an ensemble model. In a case where the ensemble model is built by using N number of prediction models 330, 332, and 334, each prediction model may be classified based on a certain criterion, and a prediction model corresponding to a specific classification criterion may be activated. The classification criterion may be variously determined based on the purpose of a game operating scenario. For example, a play style of a gamer may be classified by clustering the classification criterion as a time-series data pattern. For example, in the classification criterion, in a case where an operating scenario performs an event, events may be classified based on kinds, and a prediction model may be classified based on events or a time-series pattern of each event. As another example, a pattern of an influence of a time-series input variable corresponding to a target variable may be used as the classification criterion.

In the operation 430, the control signal generator 540 may determine a combination of active prediction models on the basis of a similarity between an influence of game attribute data determined based on learning data and an influence of attribute game data determined based on live data. Here, the influence of the game attribute data may be determined by analyzing an influence of an attribute corresponding to a prediction value of a target variable in each prediction model. The control signal generator 540 may generate a control signal for turning on/off each prediction model on the basis of the determined combination of the active prediction models. For example, the control signal generator 540 may calculate a score as a cosine similarity between an attribute influence calculated by inputting game attribute data corresponding to a generating time to each prediction model and an attribute influence calculated by inputting game attribute data extracted from previous learning data to each prediction model. In an embodiment, a prediction model where a score is greater than a threshold value may be selected. Also, the control signal generator 540 may normalize a similarity score to determine a weight value of the selected prediction model.

In another embodiment, in the operation 430, the control signal generator 540 may perform a matching operation to determine a prediction model which is to be activated for predicting a target value of a pattern calculated from live data on the basis of a certain condition used in building a model. The matching operation may be performed by calculating a similarity between a feature sequence secondarily extracted based on a certain condition from a feature extracted from test data and a corresponding feature sequence of learning data. In the learning data, when a feature sequence is provided to each user and a game operating scenario is provided to all users, an average weight value of an individually provided sequence may be calculated as a representative value, and a similarity thereof may be calculated. When the matching operation ends, the most similar prediction model may be selected or a combination of prediction models may be selected from a result of the matching operation, and thus, a control signal for turning on/off each prediction model may be generated.

In another embodiment, in the operation 430, in a case which generates a game operating scenario through a combination of basic models, the control signal generator 540 may generate an on/off control signal to activate the basic model on the basis of the combination. In predicting each basic model, as described above, a target value may be predicted, a combination of prediction values may be finally determined by reflecting a weight model of an activated model, and there may be various weight setting methods on the basis of the purpose of generating a game operating scenario.

In another embodiment, in the operation 430, the control signal generator 540 may determine all prediction models as active prediction models. That is, the control signal generator 540 may provide a control signal for turning on all prediction models, detect a weight value of each prediction model, and determine a target variable prediction value of each prediction model on the basis of the weight value. There may be various methods of performing an ensemble operation on results of several prediction models on the basis of an ensemble model, and the control signal generator 540 may generate a control signal suitable for a method of performing the ensemble operation.

In an operation 440, referring to FIG. 5, the prediction value generator 550 may drive a combination of active prediction models according to a control signal to generate a prediction value of a target variable, based on game attribute data and an operating factor.

A game operating scenario may be expressed as a combination of active prediction models. In the operation 440, each prediction model may receive, an input, a value of a model specific operating factor of time-series attribute data at a time at which a game operating scenario is to be generated, thereby predicting a temporary target value for each gamer. The model specific operating factor may be an operating factor specialized for each basic model, and thus, different values may be reflected for each model. In reflecting the values, a value of an operating factor in learning may be used, a value of an operating factor inferred from current live data may be used, an intention of a game operator may be reflected, and a hybrid method using all of a condition in learning and a condition in generating a scenario may be applied. The prediction value generator 550 may combine active prediction models to generate a final target prediction value. For example, the prediction value generator 550 may weight-average temporary target prediction values to determine a final target prediction value.

The control signal may be for determining a weight value of a prediction value of each prediction model, and in the operation 440, the prediction value generator 550 may weight-average prediction values determined by at least one prediction model on the basis of the weight value determined based on the control signal to generate a final weight value of a target variable. Here, the weight value may be determined based on a similarity between an influence of the game attribute data determined based on the learning data and an influence of the game attribute data determined based on the live data.

Additionally, in the operation 440, an attribute influence analyzer of each prediction model may analyze an influence of an operating factor and an influence of at least one piece of game attribute data corresponding to a prediction value of a target variable.

In an operation 450, the validator 560 may evaluate a game operating scenario on the basis of a target prediction value generated by the prediction value generator 550. For example, the target prediction value may be generated for each user, and thus, the validator 560 may evaluate a result based on the game operating scenario by calculating a statistic of the target prediction value on the basis of an intention of the game operating scenario. Here, an influence of an operating factor and an influence of game attribute data corresponding to the target prediction variable may be determined by an attribute influence analyzer of a prediction model.

In the operation 450, the validator 560 may determine whether the generated game operating scenario is suitable for a desired operating attribute and may evaluate the game operating scenario. For example, the operating attribute may be a value which quantitatively expresses an operating intention of a game operator.

For example, in a case where goods provided by the game operator is used as an operating attribute, classification of the goods provided by the game operator and the amount of compensation of each goods may be set as a value of the operating attribute. For example, when the game operating scenario is for providing goods to induce participation in a game and simultaneously provide minimum compensation, a variation of participation in a game based on a variation of the amount of compensation may be evaluated based on a target prediction value. Here, under a condition where an operating factor is set as the amount of compensation and a target variable is set as a degree of participation in a game, the game operating scenario may be driven and a variation of a prediction value of a target variable based on a variation of the operating factor may be analyzed and evaluated.

In the operation 450, an operating factor of a game operating scenario corresponding to each prediction model may vary based on a result of evaluation of the game operating scenario. When the operating factor varies, the operation 430 of generating a control signal and the operation 440 of generating a target prediction value may be performed on a varied operating factor again. When a new operating factor needs to be added based on the result of the evaluation, the prediction modeling unit 520 may additionally build a prediction model which reflects an added operating factor.

Moreover, in the operation 450, the validator 560 may perform a simulation on the game operating scenario on the basis of the live data. That is, the validator 560 may extract game attribute data on the basis of the live data and may drive a combination of active prediction models on the basis of a determined operating factor and a control signal to determine an influence of an attribute and a prediction value of a target variable. An influence, which is predicted when the game operating scenario is applied through a game operating scenario simulation, may be variously reviewed. Also, another variable relevant to the target prediction value may also be predicted through the game operating scenario simulation, and a side effect based on driving of the game operating scenario may be checked. The validator 560 may add game attribute data on the basis of a simulation result. In this case, in the operation 440, a game operating scenario in which the added game attribute data is reflected may be generated.

Additionally, in an operation 460, the validator 560 may actually apply the game operating scenario, and then, may validate the game operating scenario on the basis of data in which the game operating scenario is reflected. When an unpredicted result is obtained as a result of the validation, a criterion for checking whether an intention of the game operating scenario is reflected may be measured by performing various analysis including an analysis of attribute influence. Correction of a previous model, correction of a parameter, and online learning may be performed based on a result of the measurement. In detail, in this case, in the operation 410, when a value of the operating factor and true label data are available, additional learning may be performed on a prediction model which has been activated in generating the game operating scenario. In a case which generates the game operating scenario by combining basic models, the additional learning may be performed for each basic model and an activated model may be simultaneously learned. As a result, the addition learning may be learning for decreasing a difference between a real value and a value which is predicted in generating the game operating scenario, and thus, data may increase, whereby an accuracy of a model may be gradually improved. Particularly, in order to cause a desired validation, a game operating scenario sequence should be provided instead of one game operating scenario, but since influences of game operating scenarios overlap and are reflected, interpretation may be complicated and difficult. However, a game operating scenario generating method according to the present invention may previously perform a simulation through generating of a game operating scenario and target prediction based on time series and may sequentially validate, correct, and support an effect thereof. Through such a simulation, an event where a maximum effect is expected in applying a game operating scenario may be determined from among a plurality of game events and may be recommended to a game operator. For example, a user satisfying a desired target value among all users may determine an event which is the maximum. In this case, the game operating scenario generating system may input, to a prediction model, time-series game attribute data and a value of an operating factor measured through an event to generate a target prediction value.

In the game operating scenario generating method according to an embodiment of the present invention, an operating factor may be set to be customized for a whole game or a person on the basis of the purpose thereof, and target prediction based on a variation of the amount of the operating factor may be supported. Such an operating scenario generating method may be applied to a live online service, and a result thereof may be checked and updated through a simulation and validation, whereby it is possible to generate a game operating scenario and customized modeling in which a specification of an online service advancing with time. Therefore, instead of a fixed operating method, flexible operating of a game is possible. Also, even in a case where there is a factor which is difficult to quantize or is not considered in game launching, a game operator may use the system as a guide, and thus, a conventional live service operating method may be complemented. In the game operating scenario generating method according to an embodiment of the present invention, as data increases, an accuracy of prediction and a service operating policy may increase, and since the game operating scenario generating method depends on only data without depending on a service, support may be performed to generate an operating policy on the basis of a game of another genre or data. Accordingly, the game operating scenario generating method according to an embodiment of the present invention may be applied to various fields where an expert having conventional domain knowledge makes decision.

FIG. 5 is a block diagram of a game operating scenario generating system according to an embodiment of the present invention.

As described above, the game operating scenario generating system may include an extractor 210 which extracts at least one piece of game attribute data, a game operating scenario generator 510 which generates a game operating scenario on the basis of the at least one piece of game attribute data, and a validator 560 which simulates and validates the generated operating scenario, and additionally, may include a storage unit 570 which stores game log data. The game operating scenario generator 510 may include a prediction modeling unit 520 which builds at least one prediction model for determining a prediction value of a target variable on the basis of the at least one piece of game attribute data, an operating factor determiner 530 which determines an operating factor of a game operating scenario desired based on each of the at least one prediction model, a control signal generator 540 which generates a control signal for determining a combination of active prediction models, and a prediction value generator 550 which drives the combination of the active prediction models according to the control signal to generate the prediction value of the target variable, based on the game attribute data and the operating factor. Additionally, the game operating scenario generator 510 may include an attribute influence analyzer.

The gamer behavior prediction modeling system according to an embodiment of the present invention and the game operating scenario generating method and system according to an embodiment of the present invention may be implemented in a computer system, or may be recorded in a recoding medium. The computer system may include one or more processor, a memory, a user input device, a data communication bus, a user output device, and a storage. The above-described elements may perform data communication though the data communication bus.

The computer system may further include a network interface coupled to a network. The processor may be a central processing unit (CPU), or may be a semiconductor device for executing instructions stored in the memory and/or the storage.

Each of the memory and the storage may include various kinds of volatile or non-volatile storage mediums. For example, the memory may include read only memory (ROM) and random access memory (RAM).

The gamer behavior prediction modeling method according to an embodiment of the present invention and the game operating scenario generating method according to an embodiment of the present invention may be implemented in a computer. When the gamer behavior prediction modeling method according to an embodiment of the present invention and the game operating scenario generating method according to an embodiment of the present invention are performed in a computer device, computer-readable instructions may perform the gamer behavior prediction modeling method according to an embodiment of the present invention and the game operating scenario generating method according to an embodiment of the present invention.

Moreover, the gamer behavior prediction modeling method according to an embodiment of the present invention and the game operating scenario generating method according to an embodiment of the present invention may each be implemented as a computer-readable code in a computer-readable recoding medium. The computer-readable recording medium may include all kinds of recoding mediums storing data decodable by a computer system. For example, the computer-readable recording medium may include ROM, RAM, a magnetic tape, a magnetic disk, flash memory, an optical data storage device, etc. Also, the computer-readable recording medium may be distributed to a computer system connected thereto over a computer communication network and may be stored and executed as a code readable in a distributed method.

An embodiment of the present invention may provide a gamer behavior prediction modeling system based on a time-series variation of game attribute data and a method and system of generating a game operating scenario on the basis of the gamer behavior prediction modeling system.

According to an embodiment of the present invention, an influence of game attribute data corresponding to a prediction value of a target variable of a gamer may be quantized, and an influence and a significance of time-series input attribute data of the prediction value, thereby increasing an accuracy of prediction of the target variable.

According to an embodiment of the present invention, an accurate prediction model and enhanced model analysis may enable generation of a game operating scenario for providing a desired result on the basis of an in-game event or a game update.

Moreover, according to an embodiment of the present invention, a game operating policy may be determined based on a new factor analysis technique for analyzing an influence of time-series game attribute data on prediction of a target variable, instead of correlation analysis between economic attributes (goods) and gamer behavior attribute, and thus, a simulation may be performed on a breakaway of a gamer and the amount of variation of specific goods (purchasing paid items), based on an relative influence (weight) of the time-series game attribute data on prediction of the target variable. Here, the relative influence (weight) of the time -series game attribute data may be the influence of the time step(or the time unit), the influence of an attribute unit, or the influence considering both the time step and the attribute unit.

Moreover, according to an embodiment of the present invention, based on the predicted target variables from the time series of game property data collected on an individual basis, the relative influence (weight) of the operating factors (gamer preferences) related to the gamers' response sensitivity (eg, gamers leaving, purchasing paid items) is determined. By establishing the game operating policy based on the relative influence (weight), and thus, a person-based customized event based on preference of a gamer and a compensation policy based thereon may be determined.

Moreover, according to an embodiment of the present invention, by reflecting the relative influence (weight) of game operating attribute data among the time-series game attribute data in a game operation scenario or policy, and thus, the proportion of goods to be provided as events may be determined automatically.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A gamer behavior prediction modeling system comprising:
an extractor configured to extract at least one piece of game attribute data affecting a target variable;
a target variable predictor configured to determine a prediction value of the target variable from the at least one piece of game attribute data; and
an attribute influence analyzer configured to determine an influence of the at least one piece of game attribute data corresponding to the prediction value.

2. The gamer behavior prediction modeling system of claim 1, wherein
the extractor extracts the at least one piece of game attribute data to continuously output a series of game attribute data at every unit time, and
the attribute influence analyzer determines an influence of the at least one piece of game attribute data corresponding to the prediction value at a specific time.

3. A method of generating a game operating scenario by using target variable modeling based on at least one piece of game attribute data, the method comprising:
building at least one prediction model determining a prediction value of a target variable on the basis of the at least one piece of game attribute data;
determining an operating factor of the game operating scenario corresponding to the at least one prediction model;
generating a control signal for determining a combination of active prediction models; and
driving the combination of the active prediction models according to the control signal to generate the prediction value of the target variable, based on the at least one piece of game attribute data and the operating factor.

4. The method of claim 3, wherein the at least one prediction model extracts the at least one piece of game attribute data at every unit time to obtain a series of game attribute data and determines the prediction value of the target variable on the basis of the obtained series of game attribute data.

5. The method of claim 3, further comprising, when the operating factor is added, additionally building a prediction model with the added operating factor reflected therein.

6. The method of claim 3, wherein the determining of the operating factor comprises determining the operating factor on the basis of an intention of operating the game operating scenario and a response sensitivity of a gamer corresponding to the intention.

7. The method of claim 3, wherein
the at least one prediction model determines an influence of the at least one piece of game attribute data corresponding to the prediction value, and
the generating of the control signal comprises determining the combination of the active prediction models on the basis of a similarity between an influence of the at least one piece of game attribute data determined based on learning data and an influence of the at least one piece of game attribute data determined based on live data.

8. The method of claim 3, wherein the generating of the control signal comprises determining all prediction models as the active prediction models.

9. The method of claim 3, wherein
the control signal determines a weight value of the prediction value, and
the generating of the prediction value comprises weight-averaging prediction values determined by the at least one prediction model on the basis of the weight value to generate the prediction value.

10. The method of claim 9, wherein the weight value is determined based on a similarity between an influence of the at least one piece of game attribute data determined based on learning data and an influence of the at least one piece of game attribute data determined based on live data.

11. The method of claim 3, further comprising evaluating the game operating scenario on the basis of the prediction value.

12. The method of claim 3, wherein
the at least one prediction model determines an influence of the operating factor and an influence of the at least one piece of game attribute data corresponding to the prediction value, and
the method further comprises evaluating the game operating scenario on the basis of the influence of the operating factor and the influence of the at least one piece of game attribute data.

13. The method of claim 3, further comprising varying the operating factor of the game operating scenario corresponding to the at least one prediction model,
wherein the generating of the control signal and the generating of the prediction value are performed based on a varied operating factor.

14. The method of claim 3, further comprising:
performing a simulation on the game operating scenario on the basis of live data; and
adding the at least one piece of game attribute data on the basis of a result of the simulation.

15. A system for generating a game operating scenario by using target variable modeling based on at least one piece of game attribute data, the system comprising:
an extractor configured to extract the at least one piece of game attribute data;
a prediction modeling unit configured to build at least one prediction model for determining a prediction value of a target variable on the basis of the at least one piece of game attribute data;
an operating factor determiner configured to determine an operating factor of the game operating scenario corresponding to the at least one prediction model;
a control signal generator configured to generate a control signal for determining a combination of active prediction models;
a prediction value generator configured to drive the combination of the active prediction models according to the control signal to generate the prediction value of the target variable, based on the at least one piece of game attribute data and the operating factor; and
a validator configured to perform a simulation on the game operating scenario to validate the game operating scenario.
